(19) United States
(12) Patent Application Publication
(10) Pub. No.: US 2024/0064677 A1
(43) Pub. Date: Feb. 22, 2024

(54) NON-TERRESTRIAL NETWORK (NTN) TIMING ADVANCE (TA) REPORT

(71) Applicant: Lenovo (Beijing) Limited, Beijing (CN)

(72) Inventors: Zhi Yan, Beijing (CN); Hongmei Liu, Beijing (CN); Yuantao Zhang, Beijing (CN); Haiming Wang, Beijing (CN)

(73) Assignee: Lenovo (Beijing) Limited, Beijing (CN)

(21) Appl. No.: 18/269,667

(22) PCT Filed: Dec. 31, 2020
(86) PCT No.: PCT/CN2020/142238

§ 371 Date: Jun. 26, 2023

(51) Int. Cl. H04W 56/00

(52) U.S. Cl. CPC H04W 56/0045; H04W 56/0015

(57) ABSTRACT

Methods and apparatuses for reporting TA in NTN are disclosed. A method comprises transmitting a reported value in a data message, wherein the reported value is at least one of a first reported value based on an offset value, a second reported value based on a differential offset value and a third reported value based on an offset drift rate value, the differential offset value is a differential value of a reference value, the offset drift rate value is an offset drift in a time period.

### FIELD

The subject matter disclosed herein generally relates to wireless communications, and more particularly relates to methods and apparatuses for reporting TA in NTN (non-terrestrial networks).

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal) (UE), non-terrestrial networks (NTN), terrestrial network (TN), timing advance (TA), timing offset (TO), Machine-Type Communication (MTC), enhanced MTC (eMTC), Internet-of-Things (IoT), Narrowband Internet-of-Things (NB-IoT or NBIoT), Physical Uplink Shared Channel (PUSCH), NB-IoT PUSCH (NB-PUSCH, NPUSCH), Downlink control information (DCI), Low Earth Orbit (LEO), Geosynchronous Earth Orbit (GEO), Cyclic Prefix (CP), Time Division Duplex (TDD), Frequency Division Duplex (FDD), Half Duplex Frequency Division Duplex (HD-FDD), receiver and transmitter distance (RTD), Global Navigation Satellite System (GNSS), edge of coverage (EOC), Physical Downlink Control Channel (PDCCH), MTC PDCCH (MPDCCH), NB-IoT PDCCH (NPDCCH), system information block (SIB), Radio Resource Control (RRC), Random Access Channel (RACH), Physical Random Access Channel (PRACH), NB-IoT PRACH (NB-PRACH, NPRACH).

A non-terrestrial network (NTN) is a network in which a non-terrestrial element (e.g. satellite) is involved. Depending on whether the base station (e.g. eNB that is used in scenario of eMTC or NBIoT, or gNB that is used in scenario of NR), the non-terrestrial network (NTN) has two cases: for regenerative payload and for bent-pipe payload. In case of regenerative payload, the base station is located on the satellite. In case of bent-pipe payload, the base station (e.g. eNB or gNB) is located in a terrestrial place while the satellite serves as a relay point between the UE and the base station.

FIGS. 1 and 2 illustrate two different situations for bent-pipe payload.

It can be seen from FIG. 1 that, d0 is a distance (e.g. receiver and transmitter distance (RTD)) between the satellite (SAT) and the base station (gNB) where a reference point (RP) is located at the base station; d1 is a distance between the satellite and the UE. The propagation delay between the satellite and the base station (gNB), that is common to all UEs in the range of the satellite, is d0/c=T_0 (which can be referred to as common propagation delay), in which c is the speed of light. The propagation delay between the satellite and the UE, that is specific to each UE in the range of the satellite, is d1/c=T_1 (which can be referred to as UE-specific propagation delay). The timing advance (TA) is twice the value of the propagation delay (or the propagation delay is half of the TA). The timing advance (TA) can be also referred to as timing offset (TO). In the following description, TA (timing advance) is used. The TA for bent-pipe payload is 2*T_0+2*T_1, in which 2*T_0 is common TA (which is common to all UEs), and 2*T_1 is UE-specific TA (which is specific to each UE). Therefore, the TA (or whole TA) for bent-pipe payload is equal to the sum of common TA and UE-specific TA. That is, TA (or whole TA)=common TA+UE-specific TA=2*T_0+2*T_1.

FIG. 2 illustrates another example of the common TA and the UE-specific TA in NTN for bent-pipe payload. FIG. 2 differs from FIG. 1 only in that the reference point (RP) is not located at the base station (gNB in FIG. 2), but can be located in a middle place between the base station (gNB) and the satellite. The location of the reference point (RP) is predetermined (which means that it is known to the base station). According to FIG. 2, T_0 is determined according to the distance between the reference point (RP) and the satellite. That is, in FIG. 2, d0 is the distance between the satellite and the reference point (RP), and TO is the propagation delay between the satellite and the reference point (RP).

As illustrated in FIG. 2, the common TA is determined by T_0 (i.e. common TA=2*T_0), which is determined by the distance (e.g. RTD) between the satellite and the reference point (RP), which is common to all UEs within the coverage of the satellite. The UE-specific TA is determined by T_1 (i.e. UE-specific TA=2*T_1), which is determined by the distance (e.g. RTD) between the satellite and the UE, which is specific to each UE within the coverage of the satellite.

In the example of FIG. 1, the TA (=common TA+UE-specific TA) reflects the round trip delay between the base station (gNB) and the UE, in which the common TA reflects the round trip delay between the base station (gNB) and the satellite (one way delay between the base station and the satellite can be referred to as ‘feeder link delay’), and the UE-specific TA reflects the round trip delay between the satellite and the UE (one way delay between the satellite and UE can be referred to as ‘service link delay’).

On the other hand, in the example of FIG. 2, the TA (=common TA+UE-specific TA) reflects the round trip delay between the reference point (RP) and the UE, i.e. it does not reflect the round trip delay between the base station and the UE. In particular, the common TA reflects only part of the round trip delay between the base station and the UE. The round trip delay between the reference point and the base station will be handled by the base station.

As a whole, the common TA is determined by the distance between a reference point (such as at the base station (gNB) in FIG. 1, or at a predetermined location in FIG. 2) and the satellite, which in turn is determined by the position of the reference point and the position of the satellite. The UE-specific TA is determined by the distance between the satellite and the UE, which in turn is determined by the position of the satellite and the position of the UE.

The position of the reference point (such as at the base station (gNB)) is basically predetermined and known to the base station. The position of the satellite is always changing. However, the position of the satellite at any specific time point is known to (or can be calculated by) the base station, depending on satellite ephemeris information. Therefore, with the position of the satellite and the location of the reference point, the common TA at any time point is known to (or can be calculated by) the base station.

The position of a UE can be known by the UE itself, if the UE assumingly has GNSS capability (e.g. the UE has a GNSS module). The position of the UE can be acquired based on the GNSS module. If the UE also has satellite ephemeris information (or satellite moving information), the UE can calculate the UE-specific TA. Because the position of the UE can dynamically change, the base station generally does not know the exact position of each UE. On the other hand, because the coverage of the satellite can be determined (e.g. according to the elevation of the satellite and the elevation angle), the maximal UE-specific TA and the minimal UE-specific TA at any time point can be calculated by the base station on the basis of the coverage of the satellite.

Due to long round-trip delay and large cell range of NTN cell (footprint), the TA can be very large. For example, the round trip time for LEO at an elevation of 600 km can be 28.408 ms (millisecond). Some examples of the round trip time and differential one way delay between nadir and EOC (edge of coverage) paths for different satellites are illustrated in FIG. 3.

The long round-trip delay has an impact on the scheduling of PUSCH transmission.

As shown in FIG. 4, in condition of eMTC legacy, when a UE receives a DCI scheduling a PUSCH uplink transmission on MPDCCH at subframe n, the PUSCH uplink transmission is scheduled at subframe n+k (k is scheduling delay), wherein k is set to 4 for FDD. For TDD, k is determined by TDD UL/DL configuration and can be any of 4, 5, 6 and 7.

In condition of eMTC in NTN, due to long receiver and transmitter distance (RTD), an additional delay K_{offset} is introduced to modify the timing relationship. K_{offset} is related to the round trip distance between the UE and the eNB and process timing at the eNB or UE side. K_{offset} can be configured in SIB or RRC signaling. The value of the K_{offset} should be large enough to compensate TAs of all UEs within a cell (within the coverage of the satellite). For example, if the satellite is LEO, K_{offset} can be tens of milliseconds, while if the satellite is GEO, K_{offset} can be hundreds of milliseconds.

FIG. 5 illustrates scheduling NPUSCH transmissions for UEs with different TAs. Suppose the UE is a HD-FDD UE, which means that the UE should not receive NPDCCH or NPDSCH and transmit NPUSCH simultaneously. As illustrated in FIG. 5, the eNB schedules NPUSCH transmission with a DCI format NO transmitted at 0 ms, and the scheduling offset is configured as 160 ms, that is equal to scheduling delay k plus additional delay K_{offset}. That is, the NPUSCH transmission should be received at the eNB side from 160 ms.

UE1 has a TA (timing advance) TA1 equal to 120 ms. Therefore, UE1 should start transmitting the scheduled NPUSCH transmission at “scheduling offset—TA1”=160−120=40 ms, so that the eNB can start receiving the scheduled NPUSCH transmission from UE1 at 160 ms. It can be seen that there is only 40 ms time gap between the reception of DCI format NO and the transmission of corresponding NPUSCH for UE1.

UE2 has a TA (timing advance) TA2 equal to 80 ms. Therefore, UE2 should start transmitting the scheduled NPUSCH transmission at “scheduling offset—TA2”=160−80=80 ms, so that the eNB can start receiving the scheduled NPUSCH transmission from UE2 at 160 ms. It can be seen that there is 80 ms time gap between the reception of DCI format NO and the transmission of corresponding NPUSCH for UE2.

The eNB should schedule NPDSCH and NPUSCH in the above-described time gap carefully to avoid collision between UL subframe(s) and DL subframe(s). For example, as shown in FIG. 5, suppose the eNB schedules a NPDSCH transmission by another control signal, for example, DCI format N1, transmitted at 20 ms with a scheduling offset of for example 35 ms, it is possible for UE2 that has TA2 of 80 ms to receive the scheduled NPDSCH transmission without collision. On the other hand, it is impossible for UE1 that has TA1 of 120 ms to receive the scheduled NPDSCH transmission due to collision. If the eNB knows TA1 and TA2 before scheduling the NPDSCH transmission, the eNB can know that the NPDSCH can only be scheduled for UE2 but not for UE1.

However, because TA1 is calculated by UE1, while TA2 is calculated by UE2, the eNB does not know TA1 or TA2 unless UE1 or UE2 reports TA1 or TA2 to the eNB. If the eNB wants to schedule a DL transmission or UL transmission after scheduling the NPUSCH transmission, the eNB needs to know the actual start subframe of the scheduled NPUSCH transmission for each UE, or know the exact time gap between the reception of DCI format NO and the transmission of corresponding NPUSCH for each UE.

As a whole, due to HD-FDD in NBIoT, the base station should know the actual start or end subframe of the scheduled NPUSCH transmission for each UE, so that the base station can efficiently schedule further NPUSCH and/or NPDSCH transmissions. Otherwise, the base station has to assume UE with all possible TAs (propagation delays) and waste a lot of resources. In the above example, the base station cannot schedule a NPDSCH transmission with DCI format N1 transmitted at subframe 20 for any UE.

Random access procedure in NTN includes 4 steps as illustrated in FIG. 6. In step 1, when UE has location information and satellite moving information, the UE can estimate distance of the UE and the satellite or UE-specific TA. The common TA is broadcast from the base station (eNB or gNB). So, the UE can estimate the TA (or whole TA), which is used to adjust the uplink frame timing relative to the downlink frame timing, according to the UE-specific TA and the common TA (i.e. TA (or whole TA)=common TA+UE-specific TA). Then, the UE transmits Msg1 (i.e. random access preamble) to gNB by applying the estimated TA. In step 2, the UE monitors Msg2 (i.e. random access response, which is the response to Msg1) transmitted from the gNB. Msg2 is also used to schedule Msg3 transmitted by the UE. According to the receiving of Msg2, the UE can make correction of TA (e.g. correction of the estimated TA). In step 3, the UE transmits Msg3 by applying the corrected TA. In step 4, the gNB receives Msg3 and derives UE-specific TA information, and then transmits Msg4 (response to Msg3) to the UE.

According to the random access procedure in NTN, even the UE with location information can estimate TA before transmitting Msg1, the estimated TA is not carried in Msg1. Therefore, the gNB has no knowledge of the TA when transmitting Msg2 (i.e. when scheduling Msg3). The TA value is carried only in Msg3. That is, the gNB gets to know the TA value when receiving Msg3.

When receiving the TA information contained in Msg3, the base station gets to know the actual start or end subframe of the scheduled NPUSCH transmission for each UE.

However, the satellite moves constantly. So, the common TA and the UE-specific TA change constantly. Considering the satellite orbital speed of 7.5 km/s at 600 km altitude, and a minimum elevation angle on earth of approximately 10 degrees, the maximum delay drift between UE and satellite alone will be on the order of ±20 μs/s. So, it is not enough that the UE only reports TA information in Msg3.

FIG. 7 is the FIG. 6 of PCT/CN2020/120780 filed by the same applicant. As shown in FIG. 7, PCT/CN2020/120780 proposes that TA update is done in each transmission gap Y, where each transmission gap Y is inserted after (as shown in FIG. 7) or within every X duration from the beginning of the uplink transmission. The gap should be configured based on a delta TA (delta TA refers to TA drift due to satellite moving) to ensure that the delta TA does not exceed ±CP/2=±2.5 s. Therefore, TA should be updated less than every 250 ms (±125 ms). In consideration of initial TA error margin, X can be configured to 100 ms or 64 ms or 32 ms, while Y is configured to 1 ms. Alternatively, for the preamble transmission, X is configured as a multiple of preamble transmission duration (5.6 ms or 6.4 ms), for example X=16*preamble transmission duration; while Y is configured as 1 ms.

With the constantly updated TA value(s), the base station can schedule NPDSCH and NPUSCH to avoid collision between UL subframe(s) and DL subframe(s) in NTN scenario.

As a whole, in the prior arts described above, TA can be divided as common TA (which is common to all UEs) and UE-specific TA (which is specific to each UE). The UE can report TA value to the base station in msg3 and PUSCH transmission.

The reported TA value can be the value of UE-specific TA, or the value of the sum of the common TA and the UE-specific TA. In latter case, the UE has to know the common TA. Since the common TA always changes, the base station (e.g. gNB) may indicate the changed common TA frequently (e.g. periodically) to the UE by broadcast. As an alternative of always indicating the changed common TA, a common TA drift value (i.e. the difference of current common TA from previous common TA or from initially indicated common TA) can be indicated to the UE frequently (e.g. periodically) after the initially indicated common TA is indicated to the UE. The UE may derive the current common TA based on the common TA drift value and the previous common TA or the initially indicated common TA.

The prior arts only describe that TA value should be reported to the base station, but do not describe in detail what kinds of TA values are reported. Whether the TA value should be reported periodically or event-triggered? Is it enough to only report the TA value (e.g. UE-specific TA value) to the base station? If the TA value is updated in a gap period in the PUSCH transmission, is there any assist information used for determining the period of the gap period?

This invention proposes different solutions for updating TA during the NPUSCH transmission.

### BRIEF SUMMARY

Methods and apparatuses for reporting TA in NTN are disclosed.

In one embodiment, a method comprises transmitting a reported value in a data message, wherein the reported value is at least one of a first reported value based on an offset value, a second reported value based on a differential offset value and a third reported value based on an offset drift rate value, the differential offset value is a differential value of a reference value, the offset drift rate value is an offset drift in a time period. The offset value, the differential offset value and the offset drift may be a time value or a distance value.

In one embodiment, the time offset value is related to a time advance of uplink time slot before the corresponding downlink time slot. The reference value is one of a broadcast time offset, a previous first reported value and a previous time offset value.

In another embodiment, the first reported value or the second reported value is further determined by at least one of a network deployment and a set of threshold values. The time offset value and the differential time offset value are in unit of one of a symbol sample, a symbol, a time slot, millisecond, second or multiple seconds; and the distance offset value and the differential distance offset value are in unit of one of meter or kilometer.

In some embodiment, the time or distance offset drift rate indicates whether the time or distance offset drift is positive or negative in the time period.

In some embodiment, the method may further comprise receiving a configuration of a reporting period, wherein, the reported value is transmitted based on the reporting period. Alternatively, the transmitting of the reported value may be triggered by at least one of the following events: 1) the offset value is larger or smaller than or equal to a first threshold; 2) the differential offset value is larger or smaller than or equal to a second threshold; 3) the offset drift rate value is larger or smaller than or equal to a third threshold; 4) a differential offset drift rate value is larger or smaller than or equal to a fourth threshold; 5) cells or beams served are changed or switched; and 6) data transmission and reception collision.

In another embodiment, a remote unit comprises a transmitter that transmits a reported value in a data message, wherein the reported value is at least one of a first reported value based on an offset value, a second reported value based on a differential offset value and a third reported value based on an offset drift rate value, the differential offset value is a differential value of a reference value, the offset drift rate value is an offset drift in a time period. The offset value, the differential offset value and the offset drift may be a time value or a distance value.

In one embodiment, a method comprises receiving a reported value in a data message, wherein the reported value is at least one of a first reported value based on an offset value, a second reported value based on a differential offset value and a third reported value based on an offset drift rate value, the differential offset value is a differential value of a reference value, the offset drift rate value is an offset drift in a time period. The offset value, the differential offset value and the offset drift may be a time value or a distance value.

In yet another embodiment, a base unit comprises a receiver that receives a reported value in a data message, wherein the reported value is at least one of a first reported value based on an offset value, a second reported value based on a differential offset value and a third reported value based on an offset drift rate value, the differential offset value is a differential value of a reference value, the offset drift rate value is an offset drift in a time period. The offset value, the differential offset value and the offset drift may be a time value or a distance value.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIGS. 1 and 2 illustrate the concept of the common TA and the UE-specific TA in NTN;

FIG. 3 illustrates round trip time and differential one way delay for different types of satellites;

FIG. 4 illustrates the concept of additional delay;

FIG. 5 illustrates scheduling NPUSCH transmissions for UEs with different TAs;

FIG. 6 illustrates a legacy random access procedure;

FIG. 7 illustrates updating TA in a gap period;

FIG. 8 illustrates an example of the first embodiment;

FIG. 9 illustrates an example of the second embodiment;

FIG. 10 illustrates another example of the second embodiment;

FIG. 11 illustrates an example of the third embodiment;

FIG. 12 illustrates another example of the third embodiment;

FIG. 13 is a schematic flow chart diagram illustrating an embodiment of a method;

FIG. 14 is a schematic flow chart diagram illustrating an embodiment of a method; and

FIG. 15 is a schematic block diagram illustrating apparatuses according to one embodiment.

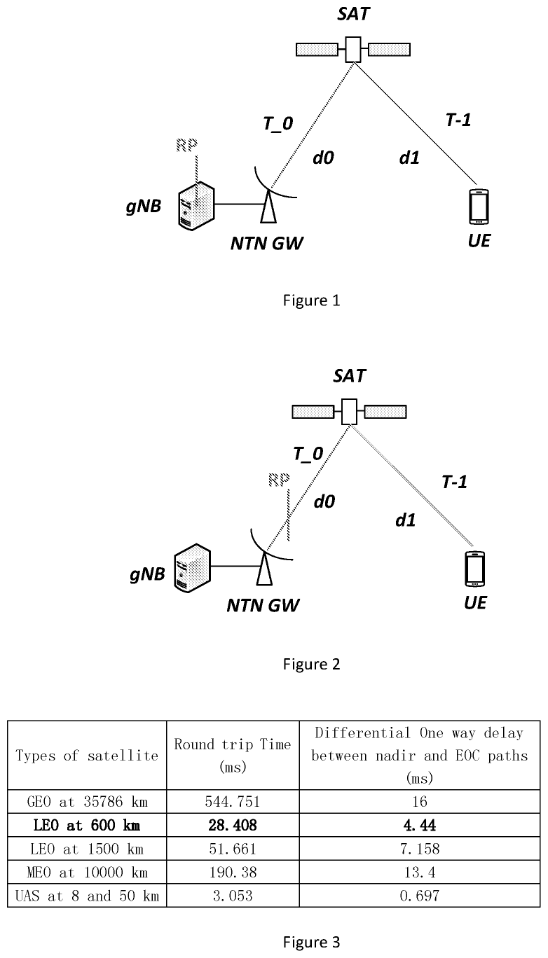

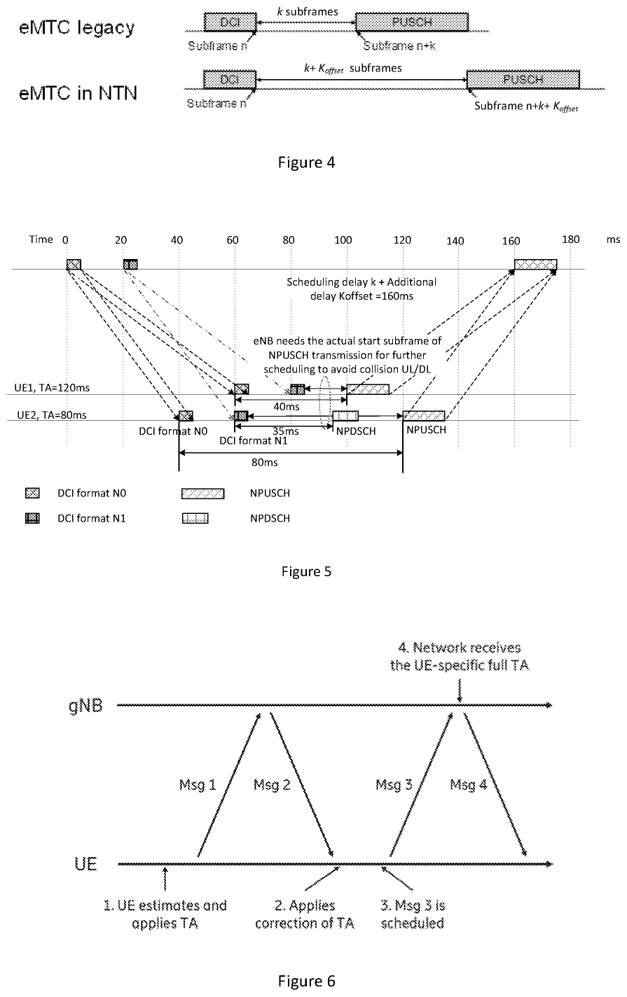

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

As described in the background part, the UE reports a TA value in msg3 and/or in the following PUSCH transmissions.

According to a first embodiment, the reported value is determined by at least one of the network deployment (e.g. LEO, GEO or etc), an estimated value and a set of threshold values.

Take the scenarios illustrated in FIG. 3 as an example. Suppose the reported value is for LEO at 600 km. It can be seen that the round trip time is 28.408 ms, while the differential one way delay between nadir and EOC paths is 4.44 ms. Therefore, the estimated value can be estimated TA value (TAest) that is in the range of 28.408±2*4.44 ms. A set of threshold values (e.g. threshold TA values) can be determined based on the range. For example, as shown in FIG. 8, the threshold TA values for the reported TA value are 25, 26, . . . , 34 (in unit of millisecond (ms)). Based on the estimated value (estimated TA value) and the set of threshold values (threshold TA values), a reported value (reported TA value) for LEO at 600 km (i.e. one of TA_0 to TA_9) is determined. For example, if 29 ms<=the estimated TA value<30 ms, TA_4 is the reported TA value.

In the example of FIG. 8, the estimated value is an estimated TA value, i.e. the value of whole TA. It is related to a time advance of uplink time slot before the corresponding downlink time slot. Alternatively, the estimated value can be a value that can derive the whole TA, which means that the whole TA can be determined according to the estimated value.

The whole TA can be represented by: whole TA=2*T_1+2*T_0=2*d1/c+2*d0/c, in which d0 is the distance between the reference point and the satellite; d1 is the distance between the satellite and the UE; TO is propagation delay between the reference point and the satellite (T_0 can be also referred to as feeder link delay); T_1 is propagation delay between the satellite and the UE (T_1 can be also referred to as service link delay); 2*T_0 is common TA (or round trip delay between the reference point and the satellite, or round trip feeder link delay); 2*T_1 is UE-specific TA (or round trip delay between the satellite and the UE, or round trip service link delay). Since d0 or T_0 or 2*T_0 is known to the base station and can be broadcast to UE by higher layer signaling, the value that can derive the whole TA can be any one of: UE-specific TA (2*T_1), whole propagation delay (i.e. one way propagation delay) (T_1+T_0), UE-specific propagation delay (T_1), distance between the reference point and the UE (d1+d0), and distance between the satellite and the UE (d1). In other words, the whole TA can be determined according to any one of UE-specific TA (2*T_1), whole propagation delay (i.e. one way propagation delay) (T_1+TO), UE-specific propagation delay (T_1), distance between the reference point and the UE (d1+d0), and distance between the satellite and the UE (d1).

The whole TA can be referred to as a propagation delay that reflects a whole of round trip delay between the base station and the UE. The UE-specific TA, the whole propagation delay and the UE-specific propagation delay can be referred to as a propagation delay that reflects a partial of round trip delay between the base station and the UE.

Depending on the estimated value based on which the reported value is derived, the set of threshold values are configured accordingly.

As a whole, the estimated value can be TA (whole TA), or UE-specific TA or some other TA value that can be used to derive the whole TA, propagation delay (whole propagation delay or UE-specific propagation delay) or some other time offset value reflecting whole or partial of the delay between the satellite and UE, or distance (distance between the UE and the reference point, or distance between the UE and the satellite) or some other distance value reflecting whole or partial of the distance between the satellite and UE. A set of threshold values can be configured for the estimated value. A reported value is obtained by comparing the estimated value with the threshold values.

When the estimated value is TA or propagation delay or time offset value, the estimated value and the threshold values therefor can be in unit of (i.e. the granularity is) one of a OFDM sample, e.g., Ts (=1/(15000*2048) seconds), a symbol, a time slot (e.g. a subframe), millisecond (ms), second (s) and multiple seconds.

When the estimated value is distance, the estimated value and the threshold values therefor can be in unit of (i.e. the granularity is) one of meter (m) and kilometer (km).

According to the first embodiment, the estimated value for each UE indicated by a reported value is reported to the base station from each UE. The base station can derive the estimated TA value (e.g. a range of the estimated TA value) for each UE according to the reported value for example by referring to FIG. 8.

With reference to FIG. 5, when UE1 reports the estimated TA (TA1=120 ms) by a reported value to the eNB and UE2 reports the estimated TA (TA2=80 ms) by another reported value to the eNB, the eNB knows the estimated TAs (TA1 and TA2) of UE1 and UE2 (i.e. the eNB knows that the time gap for UE1 is 40 ms and the time gap for UE2 is 80 ms) so that the eNB knows that a NPDSCH transmission can be scheduled between DCI format NO and NPUSCH transmission to UE2.

The reported value according to the first embodiment is based on an estimated value (e.g. estimated TA value). It is reasonable that only the reported value that is reported the first time is based on an estimated value, while the following reported values may be based on an estimated differential value.

According to a second embodiment, the reported value is a reported differential value (or a reported drift value) determined by at least one of the network deployment (e.g., LEO, GEO or etc), estimated differential value (or estimated drift value) and a set of threshold differential values (or threshold drift values). The estimated differential value is a value that can be used to derive the estimated TA based on a reference value, wherein the reference value is known to the base station.

For example, when the estimated differential value is an estimated differential TA value, the reference value can be 1) broadcast common TA; 2) configured cell specific Koffset (that is broadcast from the base station); 3) a previous reported TA value; 4) a previous estimated TA value; 5) another configured TA value (that can be broadcast from the base station). Similar to the first embodiment, the estimated differential value may alternatively be an estimated differential propagation delay value, or an estimated differential distance value.

The set of threshold differential values (or threshold drift values) are configured according to the estimated differential value.

When the estimated differential value is TA or propagation delay, the granularity of the estimated differential value or its threshold differential values can be one of a OFDM sample, (e.g. Ts), a symbol, a time slot (e.g. a subframe), millisecond (ms), second (s) and multiple seconds. When the estimated differential value is distance, the granularity of the estimated differential value or its threshold differential values can be one of meter (m) and kilometer (km).

Take the scenarios illustrated in FIG. 3 as an example. Suppose the reported value is for LEO at 600 km. As shown in FIG. 9, the differential TA value is calculated as a difference of the estimated TA value to a reference TA value (e.g. an initially estimated TA, or a configured TA value such as 28.408 ms). That is, differential TA value=current estimated TA value−reference TA value (e.g. initially estimated TA or a configured TA value). The threshold TA drift values are −4, −1, and 2 as shown in FIG. 9. Based on the estimated differential TA value (estimated drift TA value) and the set of threshold differential TA values (threshold drift TA values), a reported differential TA value (reported drift TA value) for LEO at 600 km (i.e. one of DIFFTA_0 to DIFFTA_3) is determined. For example, if −4 ms<=differential TA value (ΔTAest)<−1 ms, DIFFTA_1 is the reported differential TA value (reported drift TA value).

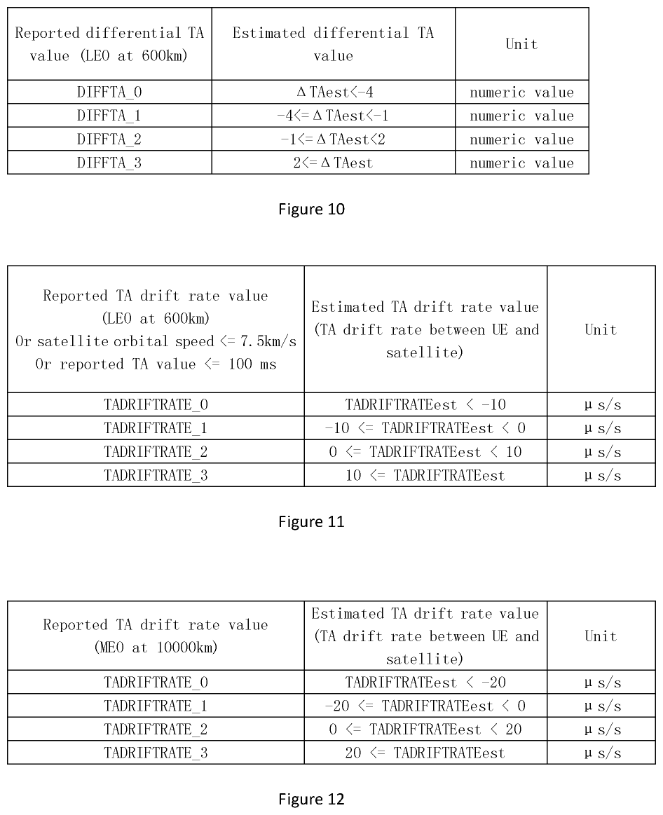

The differential TA value can be alternatively compared with an initially reported TA value as a reference value. In particular, the current estimated TA value is converted into a reported TA value according to the table shown in FIG. 8. For example, if the current estimated TA value is 26.6 ms, the corresponding reported TA value is 1 (i.e. TA_1). Suppose that the initially reported TA value, which is the reference value, is TA_4 (i.e. 4). Accordingly, the differential TA value is reported TA value corresponding to current estimated TA value (i.e. 1) minus the initially reported TA value (i.e. 4), which is equal to −3. In this alternative manner for determining the reported differential TA value, the threshold TA drift values are −4, −1, and 2 in numeric value as shown in FIG. 10. When the differential TA value is −3, DIFFTA_1 is the reported differential TA value (reported drift TA value).

The base station can calculate the current TA value based on the reported differential TA value (reported drift TA value) and the initially reported TA value (reference TA).

The bits (e.g. 4 bits) used for the reported differential value (as shown in FIG. 9 or 10) are less than the bits (e.g. 2 bits) used for the reported value (as shown in FIG. 8).

According to the first embodiment or the second embodiment, the reported value (or the reported differential value) will expire after a short period due to long propagation delay overhead signaling and satellite moving.

According to a third embodiment, an estimated drift rate value is reported to the base station so that the base station can derive a real-time TA (or propagation delay) to avoid frequently reporting. The reported drift rate vale is determined by at least one of network deployment (e.g., LEO, GEO or etc), estimated drift rate value, a set of threshold drift rate values, and speed of satellite. The estimated drift rate value is a value that can be used to derive the estimated TA based on a reference value and time, where the reference value is known to the base station. The reference value can be reported simultaneously with the estimated drift rate value, or separately. For example, the estimated drift rate value can be an estimated TA drift rate value, and the reference value is the estimated TA value according to the first embodiment. Similar to the first embodiment, the estimated drift rate value may alternatively be an estimated propagation delay drift rate value, or an estimated distance drift rate value. The set of threshold drift rate values are configured according to the estimated drift rate value (e.g. the set of threshold TA drift rate values are configured according to the estimated TA drift rate value).

When the estimated drift rate value is estimated TA drift rate value or estimated propagation delay drift rate value, the granularity of the estimated drift rate value or its threshold drift rate values is OFDM sample (e.g. Ts) or symbol or time slot (e.g. subframe) or microsecond per millisecond second or second (e.g. microsecond per second (μs/s)). When estimated drift rate value is distance, the granularity of the estimated drift rate value or its threshold drift rate values can be meter (m) or kilometer (km) per millisecond second or second (e.g. kilometer per second (km/s)).

Take the scenarios illustrated in FIG. 3 as an example. Suppose the reported value is for LEO at 600 km. The estimated TA drift rate value is calculated as a difference of the current differential TA value to previous differential TA value per time unit. That is, estimated TA drift rate value (TADRIFTRATEest)=(current TA value−previous TA value)/(differential time period), in which the differential time period is equal to the time when the current TA value is obtained minus the time when the previous TA value is obtained. The differential time period can be a fixed time period or is configured by the base station. For example, the differential time period can be 1 ms. The threshold TA drift rate values are −10, 0, 10 (μs/s) as shown in FIG. 11. Based on the estimated TA drift rate value and the threshold drift rate values, a reported drift rate value for LEO at 600 km (i.e. one of TADRIFTRATE_0 to TADRIFTRATE_3) is determined. For example, if −10 μs/s<=TADRIFTRATEest<0, TADRIFTRATE_1 is the reported TA drift rate value.

The threshold drift rate values can be configured as only one threshold drift rate value 0. In this condition, the time or distance offset drift rate indicates whether the time or distance offset drift is positive or negative in the time period.

The TA drift value is determined directly according to the speed of satellite. So, the estimated TA drift rate value can be alternatively determined according to the speed of satellite and time. The granularity of the estimated TA drift rate value can be configured according to different speeds of satellite. For example, if the speed of satellite is larger than 600 km/h, the granularity can be configured as 10 μs/s; and if the speed of satellite is smaller than 600 km/h, the granularity can be configured as 5 μs/s.

Based on the reported TA drift rate value and the reference value, the base station can calculate the real-time TA. For example, if the estimated TA drift rate is −5 μs/s and the reference value (e.g. initial reported TA value) is 100 ms, the real-time TA is 100 ms+estimated TA drift rate*time (s). For example, after 10 μs (10 seconds), the real-time TA is 100 ms−5 μs/s*10 s=99.95 ms.

Therefore, the base station can derive real-time TA based on the reference value (e.g. the initial reported TA value) and TA drift rate value in a long period without requiring new TA reporting.

FIG. 12 illustrates another example according to the third embodiment, which is for reporting TA drift rate value for MEO at 10000 km. The threshold drift rate values are configured as −20, 0, 20 (μs/s) as shown in FIG. 11.

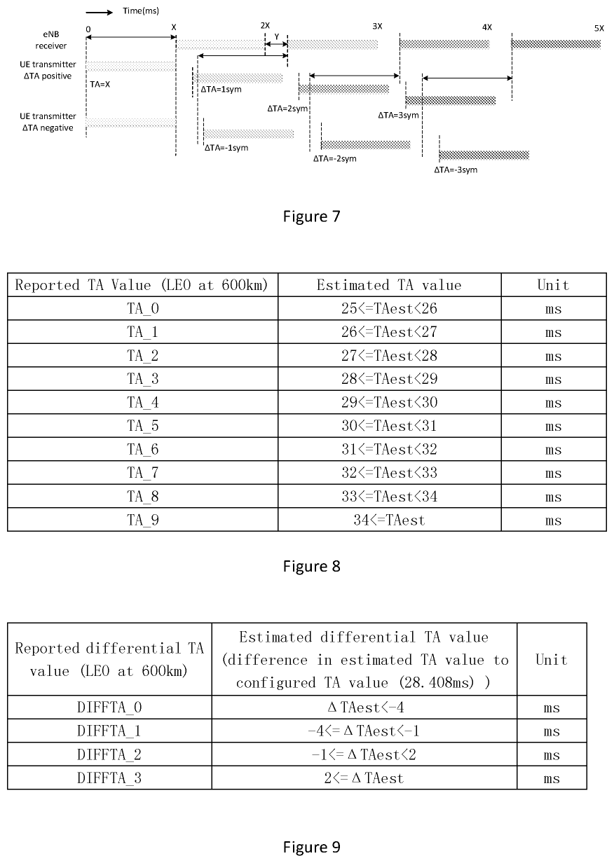

Based on the reported TA drift rate value (the estimated TA drift rate value), the base station can configure the duration X relative to the transmission gap Y illustrated in FIG. 7. For example, if the estimated TA drift rate value corresponding to the reported TA drift rate value is larger than 5 μs/s, X can be configured as 256 ms; otherwise, X can be configured as 128 ms.

According to a fourth embodiment, the reporting according to any of the first, the second and the third embodiments is periodically triggered or event-triggered. That is, when the reported value, the reported differential value, the reported drift rate value (or the reported value and the reported drift rate value) are reported is triggered periodically or by an event.

If reporting is triggered periodically, the period of TA reporting is configured by the base station. For example, the period of TA reporting is determined by network deployment (e.g. LEO, GEO or etc). The period of TA reporting can be configured by higher layer signaling, e.g. by choosing a value from a preconfigured or fixed set of values.

If the reporting is triggered by an event, the event can be any of:

Event 1: Estimated value (e.g. estimated TA value TAest in FIG. 8) is larger or smaller than or equal to a threshold (e.g. difference of the estimated TA value to a reference TA).

Event 2: Estimated differential value (e.g. estimated differential TA value ΔTAest in FIG. 9 or 10) is larger or smaller than or equal to a threshold (e.g. difference of the estimated differential TA value to a reference differential TA value).

Event 3: Estimated drift rate value (e.g. estimated TA drift rate value TADRIFTRATEest in FIG. 11 or 12) is larger or smaller than or equal to a threshold (e.g. difference of the estimated TA drift rate value to a reference TA drift rate value).

Event 4: Differential drift rate value (e.g. differential TA drift rate value, that is difference of a first reported (estimated) TA drift rate value to a second reported (estimated) TA drift rate value) is larger or smaller than or equal to a threshold.

Event 5: Cell or beam is switched or changed.

Event 6: Scheduling uplink transmission and downlink reception collision

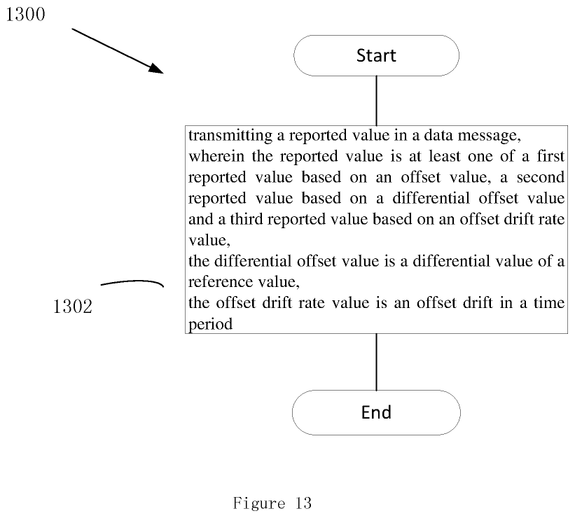

FIG. 13 is a schematic flow chart diagram illustrating an embodiment of a method 1300 according to the present application. In some embodiments, the method 1300 is performed by an apparatus, such as a remote unit. In certain embodiments, the method 1300 may be performed by a processor executing program code, for example, a microcontroller, a microprocessor, a CPU, a GPU, an auxiliary processing unit, a FPGA, or the like.

The method 1300 may include 1302 transmitting a reported value in a data message, wherein the reported value is at least one of a first reported value based on an offset value, a second reported value based on a differential offset value and a third reported value based on an offset drift rate value, the differential offset value is a differential value of a reference value, the offset drift rate value is an offset drift in a time period. The offset value, the differential offset value and the offset drift may be a time value or a distance value.

The time offset value is related to a time advance of uplink time slot before the corresponding downlink time slot. The reference value is one of a broadcast time offset, a previous first reported value and a previous time offset value. The first reported value or the second reported value is further determined by at least one of a network deployment and a set of threshold values.

The time offset value and the differential time offset value are in unit of one of a symbol sample, a symbol, a time slot, millisecond, second or multiple seconds; and the distance offset value and the differential distance offset value are in unit of one of meter or kilometer. The time or distance offset drift rate indicates whether the time or distance offset drift is positive or negative in the time period.

The method may further comprise receiving a configuration of a reporting period, wherein, the reported value is transmitted based on the reporting period. Alternatively, the transmitting of the reported value may be triggered by at least one of the following events: 1) the offset value is larger or smaller than or equal to a first threshold; 2) the differential offset value is larger or smaller than or equal to a second threshold; 3) the offset drift rate value is larger or smaller than or equal to a third threshold; 4) a differential offset drift rate value is larger or smaller than or equal to a fourth threshold; 5) cells or beams served are changed or switched; and 6) data transmission and reception collision.

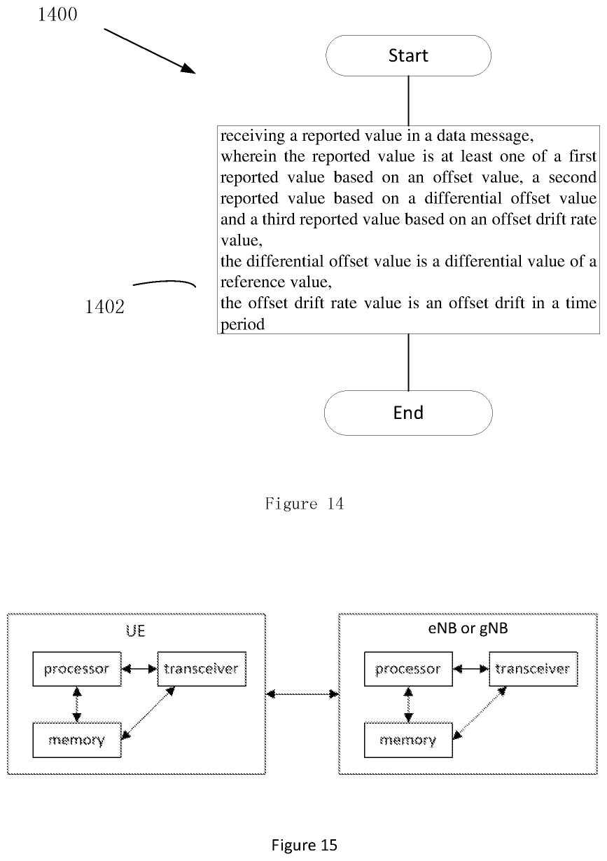

FIG. 14 is a schematic flow chart diagram illustrating an embodiment of a method 1400 according to the present application. In some embodiments, the method 1400 is performed by an apparatus, such as a base unit. In certain embodiments, the method 1400 may be performed by a processor executing program code, for example, a microcontroller, a microprocessor, a CPU, a GPU, an auxiliary processing unit, a FPGA, or the like.

The method 1400 may include 1402 receiving a reported value in a data message, wherein the reported value is at least one of a first reported value based on an offset value, a second reported value based on a differential offset value and a third reported value based on an offset drift rate value, the differential offset value is a differential value of a reference value, the offset drift rate value is an offset drift in a time period. The offset value, the differential offset value and the offset drift may be a time value or a distance value.

The time offset value is related to a time advance of uplink time slot before the corresponding downlink time slot. The reference value is one of a broadcast time offset, a previous first reported value and a previous time offset value. The first reported value or the second reported value is further determined by at least one of a network deployment and a set of threshold values.

The time offset value and the differential time offset value are in unit of one of a symbol sample, a symbol, a time slot, millisecond, second or multiple seconds; and the distance offset value and the differential distance offset value are in unit of one of meter or kilometer. The time or distance offset drift rate indicates whether the time or distance offset drift is positive or negative in the time period.

The method may further comprise transmitting a configuration of a reporting period, wherein, the reported value is received based on the reporting period.

FIG. 15 is a schematic block diagram illustrating apparatuses according to one embodiment.

Referring to FIG. 15, the UE (i.e. the remote unit) includes a processor, a memory, and a transceiver. The processor implements a function, a process, and/or a method which are proposed in FIG. 13.

The remote unit comprises a transmitter that transmits a reported value in a data message, wherein the reported value is at least one of a first reported value based on an offset value, a second reported value based on a differential offset value and a third reported value based on an offset drift rate value, the differential offset value is a differential value of a reference value, the offset drift rate value is an offset drift in a time period. The offset value, the differential offset value and the offset drift may be a time value or a distance value.

The time offset value is related to a time advance of uplink time slot before the corresponding downlink time slot. The reference value is one of a broadcast time offset, a previous first reported value and a previous time offset value. The first reported value or the second reported value is further determined by at least one of a network deployment and a set of threshold values.

The time offset value and the differential time offset value are in unit of one of a symbol sample, a symbol, a time slot, millisecond, second or multiple seconds; and the distance offset value and the differential distance offset value are in unit of one of meter or kilometer. The time or distance offset drift rate indicates whether the time or distance offset drift is positive or negative in the time period.

The remote unit may further comprise a receiver that receives a configuration of a reporting period, wherein, the transmitter transmits the reported value based on the reporting period. Alternatively, the transmitting of the reported value may be triggered by at least one of the following events: 1) the offset value is larger or smaller than or equal to a first threshold; 2) the differential offset value is larger or smaller than or equal to a second threshold; 3) the offset drift rate value is larger or smaller than or equal to a third threshold; 4) a differential offset drift rate value is larger or smaller than or equal to a fourth threshold; 5) cells or beams served are changed or switched; and 6) data transmission and reception collision.

The eNB or gNB (i.e. base unit) includes a processor, a memory, and a transceiver. The processor implements a function, a process, and/or a method which are proposed in FIG. 14.

The base unit comprises a receiver that receives a reported value in a data message, wherein the reported value is at least one of a first reported value based on an offset value, a second reported value based on a differential offset value and a third reported value based on an offset drift rate value, the differential offset value is a differential value of a reference value, the offset drift rate value is an offset drift in a time period. The offset value, the differential offset value and the offset drift may be a time value or a distance value.

The time offset value is related to a time advance of uplink time slot before the corresponding downlink time slot. The reference value is one of a broadcast time offset, a previous first reported value and a previous time offset value. The first reported value or the second reported value is further determined by at least one of a network deployment and a set of threshold values.

The time offset value and the differential time offset value are in unit of one of a symbol sample, a symbol, a time slot, millisecond, second or multiple seconds; and the distance offset value and the differential distance offset value are in unit of one of meter or kilometer. The time or distance offset drift rate indicates whether the time or distance offset drift is positive or negative in the time period.

The base unit may further comprise a transmitter that transmits a configuration of a reporting period, wherein, the receiver receives the reported value based on the reporting period.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a memory; and
a processor coupled to the memory, the processor configured to cause the apparatus to:
transmit a timing advance value in a data message, the timing advance value being based at least in part on a time offset value and the time offset value pertaining to a timing advance of an uplink time slot before a corresponding downlink time slot.

2. The apparatus of claim 1, wherein the time offset value comprises a time value.

3. (canceled)

4. The apparatus of claim 2, wherein the processor is configured to cause the apparatus to transmit a reference value, and the reference value comprises at least one of a broadcast time offset, a previous first reported value, or a previous time offset value.

5. The apparatus of claim 1, wherein the processor is configured to cause the apparatus to transmit one or more of a first reported value or a second reported value, and the one or more of the first reported value or the second reported value is further determined by at least one of a network deployment or a set of threshold values.

6. The apparatus of claim 2, wherein, the time offset value is specified in unit of a symbol sample.

7. The apparatus of claim 2, wherein the time offset value indicates whether the time offset value is positive or negative in a time period.

8. The apparatus of claim 1, wherein the processor is configured to cause the apparatus to receive a configuration of a reporting period, and transmit a reported value based on the reporting period.

9. The apparatus of claim 1, wherein transmission of the timing advance value is triggered by a differential offset value being larger, smaller, or equal to a threshold.

10. (canceled)

11. (canceled)

12. (canceled)

13. The apparatus of claim 1, wherein the time offset value is specified in unit of symbol sample.

14. The apparatus of claim 1, wherein the processor is configured to cause the apparatus to transmit the timing advance value based at least in part on a differential time offset value being larger than or equal to a second threshold.

15. The apparatus of claim 14, wherein the differential time offset value comprises a variation between a current timing advance value and a previous timing advance value.

16. A method, comprising:
transmitting a timing advance value in a data message, the timing advance value being based at least in part on a time offset value and the time offset value pertaining to a timing advance of an uplink time slot before a corresponding downlink time slot.

17. The method of claim 16, wherein the time offset value comprises a time value.

18. The method of claim 17, further comprising transmitting a reference value, the reference value comprising at least one of a broadcast time offset, a previous first reported value, or a previous time offset value.

19. The method of claim 16, further comprising transmitting one or more of a first reported value or a second reported value and determining the one or more of the first reported value or the second reported value by at least one of a network deployment or a set of threshold values.

20. The method of claim 17, wherein the time offset value is specified in unit of a symbol sample.

21. The method of claim 17, wherein, the time offset value indicates whether the time offset value is positive or negative in a time period.

22. The method of claim 16, further comprising: receiving a configuration of a reporting period, wherein, and transmitting a reported value based on the reporting period.

23. The method of claim 16, transmitting the timing advance value is triggered by a differential offset value being larger, smaller, or equal to a threshold.

24. An apparatus, comprising:
a memory; and
a processor coupled to the memory, the processor configured to cause the apparatus to:
receive a timing advance value in a data message, the timing advance value being based at least in part on a time offset value and the time offset value pertaining to a timing advance of an uplink time slot before a corresponding downlink time slot.
